(19) United States
(12) Patent Application Publication
(10) Pub. No.: US 2015/0120815 A1
(43) Pub. Date: Apr. 30, 2015

(54) REMOTE MULTI-CLIENT ACCOMMODATING SYSTEM AND HOST COMPUTER

(71) Applicant: NEC Corporation, Minato-ku, Tokyo (JP)

(72) Inventor: Junichi Higuchi, Tokyo (JP)

(21) Appl. No.: 14/401,910

(22) PCT Filed: May 20, 2013
(86) PCT No.: PCT/JP2013/003188

§ 371 Date: Nov. 18, 2014

(30) Foreign Application Priority Data
May 28, 2012 (JP) 2012-120753

(51) Int. Cl. H04L 29/08; G06F 13/40; H04L 29/06

(52) U.S. Cl. CPC H04L 67/10; H04L 67/42; G06F 13/4027
USPC 709/203

(57) ABSTRACT

According to the present invention, a remote terminal (12) includes: an IO device (210) that is used as physical resources of a host computer (11); and an IO-side bridge (211) that performs processing of connecting with the host computer (11), and the host computer (11) includes: a CPU-side bridge (112) that performs processing of connecting with the remote terminal (21); an allocation setting unit (4311) that allocates the IO device (210) of the remote terminal (21) to an application running on the host computer (11); and a routing unit (4312) that performs processing of transferring information between the application to which the IO device (210) is allocated and the IO device (210), and prevents processing of transferring information between the application and the IO device (210) which is not allocated to the application.

### TECHNICAL FIELD

The present invention relates to a remote multi-client accommodating system including a plurality of remote client terminals that are distributed on a network and a host computer accommodating the terminals, a host computer, and a remote multi-client resource-allocating method, in particular a technology of improving efficiency of the remote client terminals.

### BACKGROUND ART

In recent years, a remote multi-client accommodating system using a terminal service and the like, which is disclosed in Patent Literature 1 and Non-Patent Literature 1, is widely used. FIG. 12 is a block diagram showing a popular remote multi-client accommodating system. In the system, a host computer such as a server carries out processing of executing an application. The host computer connects with a remote terminal, such as a thin client, and a user carries out operations by using remote connection from the remote terminal to the host computer.

In a system of terminal system type, which is described in Non-Patent Literature 1, for example, a terminal service is carried out on a terminal server. On the terminal server, remote terminal software operates, which is loaded in a CPU and a memory. A user interface component displaying a state of a desktop is transferred to a client (i.e. a remote terminal) according to a display protocol such as Remote Display Protocol (RDP). The remote terminal transfers information on a user's key strokes and mouse operations to the terminal server. Thereby the user can handle a virtualized session as the user's own computer.

### CITATION LIST

### Patent Literature

Patent Literature 1: Japanese Patent Application Laid-Open No. 2010-267146

### Non-Patent Literature

Non-Patent Literature 1: “Brief terminal service of Windows Server 2008” [online], Nov. 26, 2007, Microsoft Corporation, P3,
[Searched in May 8, 2012], internet
<URL:www.dell.com/downloads/global/support/I09_Terminal_Services.pdf>

### SUMMARY OF INVENTION

### Technical Problem

In the terminal service type remote multi-client accommodating system described in the Patent Literature 1 or Non-Patent Literature 1, devices are used by emulation. Therefore, there is a problem that IO (Input/Output) performance, such as a response of a screen display and a response of a keyboard, on the remote terminal is low. Moreover, types of devices which are available on the remote terminal are limited. Therefore, there is a problem that applications working on the terminal service are restricted.

An object of the present invention is to provide a remote multi-client accommodating system, a host computer, and a method of allocating remote multi-client resources, which are able to improve IO performance of a remote terminal and are able to ease restrictions on available IO devices.

### Solution to Problem

A remote multi-client accommodating system according to the present invention is a remote multi-client accommodating system including a host computer and a remote terminal which are connected with each other through a network, wherein the remote terminal includes: an IO device that is used as physical resources of the host computer; and an IO-side bridge that performs processing of connecting with the host computer, and the host computer includes: a CPU-side bridge that performs processing of connecting with the remote terminal; an allocation setting unit that allocates the IO device of the remote terminal to an application running on the host computer; and a routing unit that performs processing of transferring information between the application to which the IO device is allocated and the IO device, and prevents processing of transferring information between the application and the IO device which is not allocated to the application.

A host computer according to the present invention is a host computer being used in a remote multi-client accommodating system and being connected with a remote terminal through a network, including: a CPU-side bridge that connects with an IO-side bridge of the remote terminal through the network, and performs processing of connecting with the remote terminal; an allocation setting unit that allocates the IO device of the remote terminal to an application running on the host computer, the IO device being used as physical resources; and a routing unit that performs processing of transferring information between the application to which the IO device is not allocated and the IO device, and prevents processing of transferring information between the application and the IO device which is not allocated to the application.

A remote multi-client resource-allocating method according to the present invention is a remote multi-client resource-allocating method being used in a host computer being connected with a remote terminal through a network, including: connecting with an IO-side bridge of the remote terminal through the network, and performing processing of connecting with the remote terminal; allocating an IO device of the remote terminal to an application running on the host computer, the IO device being used as physical resources; and performing processing of transferring information between the application to which the IO device is allocated and the IO device, and preventing processing of transferring information between the application and the IO device which is not allocated to the application.

### Advantageous Effects of Invention

According to the present invention, it is able to improve IO performance of the remote terminal, and to ease restriction on available IO devices.

### BRIEF DESCRIPTION OF DRAWINGS

FIG. 1 is a block diagram illustrating a structure of a first exemplary embodiment of a remote multi-client accommodating system according to the present invention,

FIG. 2 is a block diagram illustrating a hardware structure of a host computer,

FIG. 3 is a block diagram illustrating a structure of a remote terminal,

FIG. 4 is a block diagram illustrating a software structure of a host computer,

FIG. 5 is a block diagram illustrating a structure of a device control unit group,

FIG. 6 is a block diagram illustrating another structure of a device control unit group,

FIG. 7 is a block diagram illustrating a structure of a remote terminal according to a second exemplary embodiment,

FIG. 8 is a block diagram illustrating another structure of a remote terminal according to the second exemplary embodiment,

FIG. 9 is a block diagram illustrating further another structure of a remote terminal according to the second exemplary embodiment,

FIG. 10 is a block diagram illustrating a structure of a device control unit group according to a third exemplary embodiment,

FIG. 11 is a block diagram illustrating a structure of a main part of the remote multi-client accommodating system according to the present invention,

FIG. 12 is a block diagram illustrating a general remote multi-client accommodating system.

### DESCRIPTION OF EMBODIMENTS

Exemplary embodiments according to the present invention are described below in detail with reference to drawings.

### Exemplary Embodiment 1

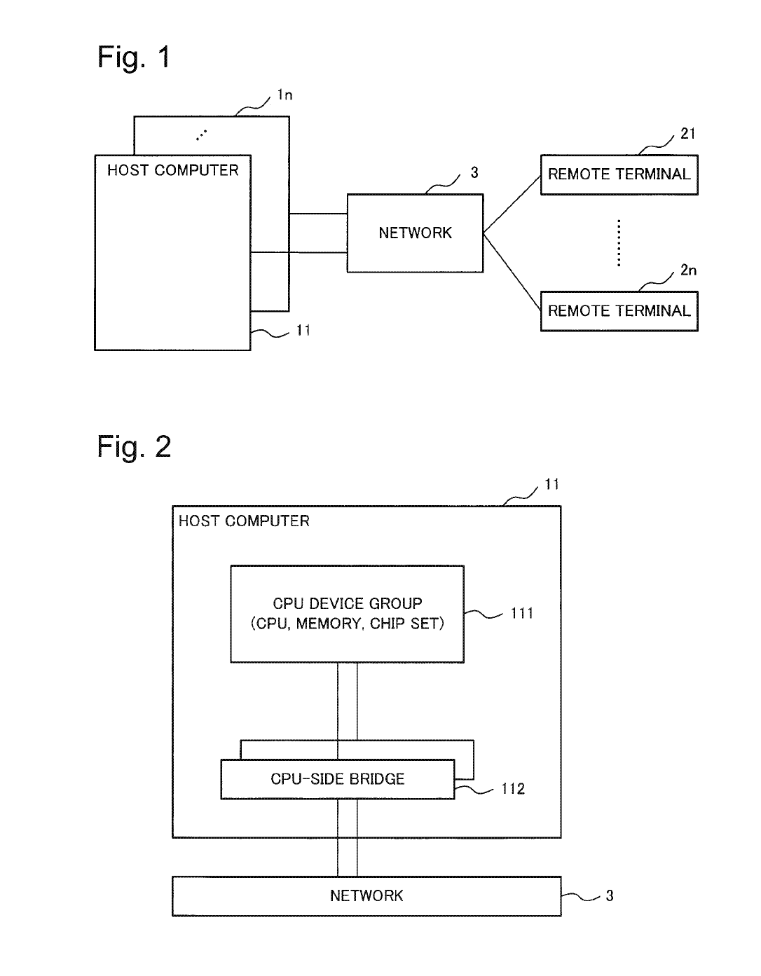

FIG. 1 is a block diagram illustrating a structure of a first exemplary embodiment (i.e. Exemplary Embodiment 1) of a remote multi-client accommodating system according to the present invention. As shown in FIG. 1, the remote multi-client accommodating system according to the present exemplary embodiment includes one or a plurality of host computers 11 to 1n, one or a plurality of remote terminals 21 to 2n, and a network 3. The host computers 11 to 1n are connected with the remote terminals 21 to 2n through the network 3.

FIG. 2 is a block diagram illustrating a hardware structure of the host computer. The host computer 11 includes a CPU device group 111 including a CPU, a memory and a chipset, and a CPU-side bridge 112.

The host computer 11 may include a plurality of the CPU-side bridges 112. The CPU device group 111 and the CPU-side bridge 112 are connected by a computer internal bus such as a PCI (Peripheral Component Interconnect) bus or a PCI Express bus. The CPU-side bridge 112 is connected with the network 3 through Ethernet (registered trade mark), etc.

When the remote multi-client accommodating system according to the present exemplary embodiment has a plurality of the host computers, the other host computers 12 to 1n also have structures similar to the structure shown in FIG. 2.

The CPU device group 111 is a group of CPU devices which are used in a generic computer, a built-in dedicated computer, a high-performance computer, a super computer, or the like, and is a device group which loads and executes software.

The CPU-side bridge 112 carries out processing concerning connection between the CPU device group 111 and the remote terminals 21 to 2n, transforms packets transmitted from the CPU device group 111 and packets transmitted from the network 3 so as to be transferred to desired destinations, and carries out transmission. The CPU-side bridge 112 generates a control packet if necessary, and transmits the packet to the CPU device group 111 or the remote terminals 21 to 2n. The CPU-side bridge 112 acquires device information on the CPU device group 111, and transmits the device information together with an own group ID that is assigned to the CPU-side bridge as the control packet.

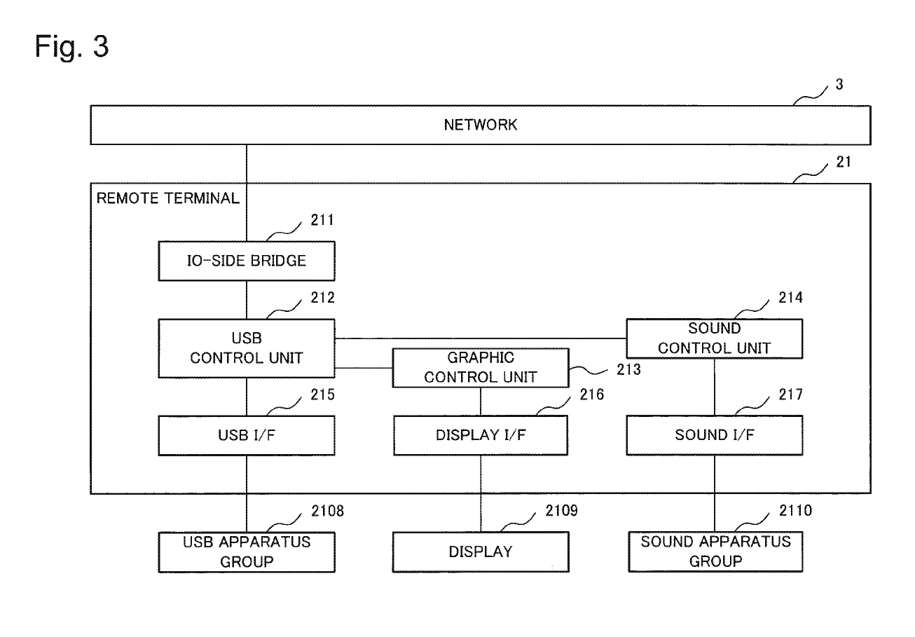

FIG. 3 is a block diagram illustrating a structure of the remote terminal 21. The remote terminal 21 includes an IO-side bridge 211, a USB control unit 212, a graphic control unit 213, a sound control unit 214, a USB interface (I/F) 215, a display I/F 216, and a sound I/F 217. The remote terminal 21 may include a plurality of IO-side bridges 211. The remote terminal 21 does not have software controlling the whole of the remote terminal 21 (e.g. OS (Operating System)). In the following descriptions, the USB control unit 212, the graphic control unit 213, and the sound control unit 214 may be referred to as an IO device.

The IO-side bridge 211 is connected with the network 3 by Ethernet or the like, and is connected with the USB control unit 212 through a computer internal bus such as a PCI bus, a PCI Express bus, or the like.

The IO-side bridge 211 carries out processing concerning connection between the IO devices, such as the USB control unit 212, and the host computers 11 to 1n, transforms packets from the IO devices and packets from the network 3 so as to be transferred to desired destinations, and carries out transmission. The IO-side bridge 211 generates the control packet if necessary, and transmits the packet to the IO devices or the host computer 11. The IO-side bridge 211 acquires device information on the IO devices, and transmits the device information together with an own group ID that is assigned to the IO-side bridge 211 as the control packet.

The USB control unit 212 is connected with the graphic control unit 213 and the sound control unit 214 through the USB bus. The USB control unit 212 is connected with a USB apparatus group 2108 through the USB I/F 215 via the USB bus. The USB apparatus group 2108 includes, for example, a USB key board, a USB mouse, a USB storage device, and a USB camera. The USB control unit 212 is a common USB controller and controls the USB apparatus group 2108.

The graphic control unit 213 is connected with a display 2109 through the display I/F 216. The graphic control unit 213 is a common graphic controller and carries out control of graphic output and image processing.

The sound control unit 214 is connected with a sound apparatus group 2110 through the sound I/F 217. The sound apparatus group 2110 includes, for example, a speaker, a headphone, a headset and the like. The sound control unit 214 is a common sound controller and carries out input/output control of sound and sound processing. The graphic control unit 213 and the sound control unit 214 may be integrated and may exist as one control unit.

In the following descriptions, the USB apparatus group 2108, the display 2109, and the sound apparatus group may be referred to as a physical device. When the remote multi-client accommodating system according to the present exemplary embodiment includes a plurality of the remote terminals, the other remote terminals 22 to 2n also have structures similar to the structure shown in FIG. 3.

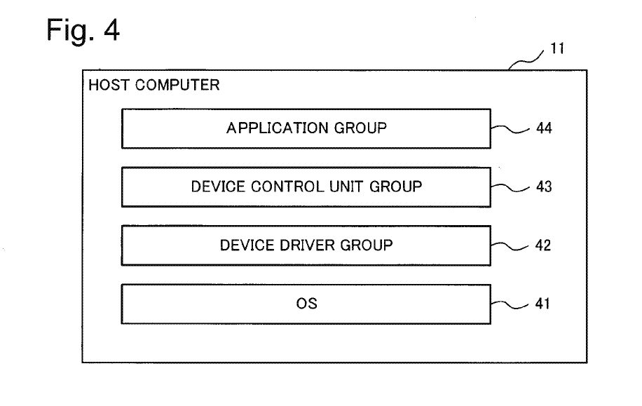

FIG. 4 is a block diagram illustrating a software structure of a host computer. The host computer 11 includes an OS (Operating System) 41, a device driver group 42 including one or a plurality of device drivers, a device control unit group 43 including one or a plurality of device control units, and an application group 44 including one or a plurality of applications.

The OS 41 has a function of a common OS such as Microsoft Windows (registered trademark), Linux (registered trademark), and does not have a function specialized for the remote multi-client system according to the present exemplary embodiment.

The device driver group 42 supports devices of the remote terminal 21 to 2n, and includes common device drivers controlling the devices.

The device control unit group 43 controls access between the application group 44 and the physical device of the remote terminal 21.

The application group 44 is an assembly of software by which a user carries out desired operations.

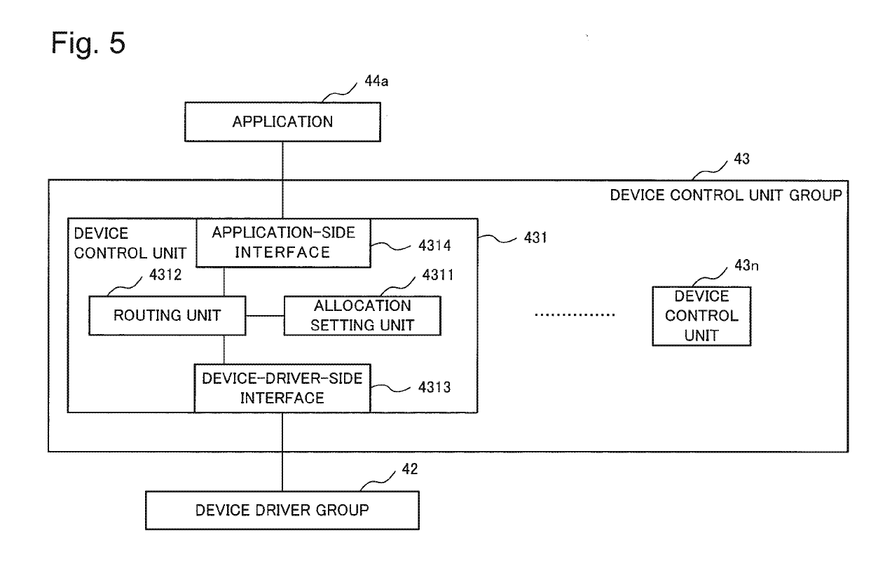

FIG. 5 is a block diagram illustrating a structure of the device control unit group 43. The device control unit group 43 includes a plurality of device control units 431 to 43n. A structure and a function of the device control unit 431 are described below, which are the same as the structures and the functions of the other device control units 432 to 43n.

The device control unit 431 is connected with an application 44a which is an allocation target in the application group 44, and with the device driver group 42 supporting the physical devices. The device control unit 431 includes an allocation setting unit 4311, a routing unit 4312, a device-driver-side interface 4313, and an application-side interface 4314.

The allocation setting unit 4311 is connected with the routing unit 4312, performs settings of an IO device and the physical device of the remote terminal 21, which are allocated to applications in the application group 44, and reflects the settings to the routing unit 4312.

The routing unit 4312 is connected with the device-driver-side interface 4313 and the application-side interface 4314. The routing unit 4312 transfers display information, sound information, and other information which are transmitted from the application's side to the device driver (which is one of the device driver group 42) supporting the physical device which is allocated to the application.

The routing unit 4312 transfers operation information, sound information and other information which are transmitted from a device driver supporting a physical device to the application to which the physical device is allocated in the application group 44.

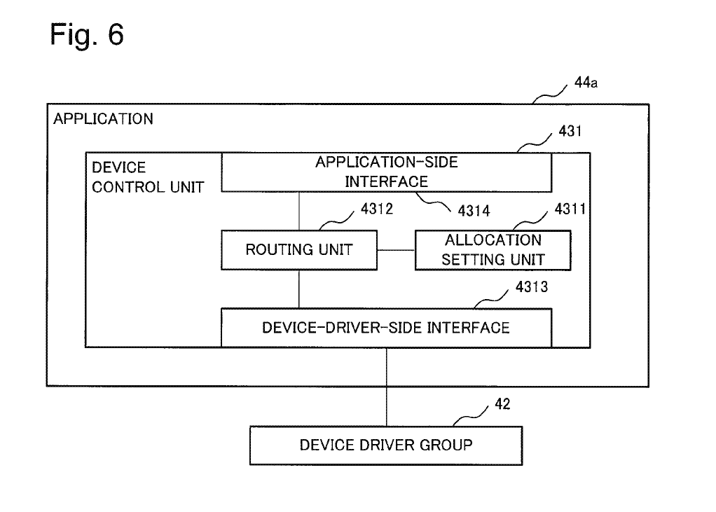

FIG. 6 is a block diagram illustrating another structure of the device control unit group. FIG. 6 illustrates an example of a structure in which the device control unit 431 is included in the application 44a included in the application group 44. According to the example shown in FIG. 6, the application 44a includes the device control unit 431, and the device control unit 431 controls a device which the application 44a uses. The structure of the device control unit 431 shown in FIG. 6 is the same as the structure of the device control unit 431 shown in FIG. 5.

Next, an operation of the remote multi-client accommodating system according to the present exemplary embodiment is described. Concerning the host computers 11 to 1n, an operation of the host computer 11 is explained below as an example. Operations of the host computers 12 to 1n are similar to the example. Concerning the remote terminals 21 to 2n, an operation of the remote terminal 21 is explained below as an example. Operations of the remote terminals 22 to 2n are similar to the example.

The remote terminal 21 is recognized as physical resources of the host computer 11 and works. It is preferable that the remote terminal 21 is turned on prior to the host computer 11. However, it is possible for the remote terminal 21 to be recognized as the physical resources by hot plug of PCI Express/USB even when the remote terminal 21 is turned on after the host computer 11 is turned on.

The OS 41 and the device driver group 42 of the host computer 11 carry out setting to enable the IO device of the remote terminal 21 and the physical device connected with the IO device to be used as the physical resources of the host computer 11. When the setting is carried out, the CPU-side bridge 112 of the host computer 11 works as an Upstream-side bridge of a PCI Express switch, and the IO-side bridge 211 of the remote terminal 21 works as an Downstream-side bridge. Lower level devices (i.e. PCI Express devices) of the IO-side bridge 211 are virtualized so as to be considered by the OS 41 and the device driver group 42 to be connected through the PCI Express switch.

After that, the device control unit group 43 of the host computer 11 performs settings of allocation of the IO device and the physical device to an application. The allocation setting unit 4311 of the device control unit 431 selects an application to allocate in the application group 431. When the device control unit 431 is prepared in advance for each of the applications or is embedded in each of the applications, the device control unit 431 carries out allocation to the application.

When allocating the remote terminal 21 to, for example, a specific application 44a, the allocation setting unit 4311, as described above, of the device control unit 431 for the application 44a or of the device control unit 431 included in the application 44a selects the JO device of the remote terminal 21 and carries out the setting. When selecting the remote terminal 21, the allocation setting unit 4311 has to identify the remote terminal 21. As the identifying method, there are a plurality of methods described below.

A first identifying method is a method of identifying using a unique value of the IO-side bridge 211. The unique value which is not duplicated in the network 3 is allocated to the IO-side bridge 211 in advance. The host computer 11 is able to acquire the unique value by using the CPU-side bridge 112 and the driver for the CPU-side bridge in the device driver group 42. When allocating a specific remote terminal 21, the allocation setting unit 4311 designates the unique value. The designated IO-side bridge 211 and the lower level IO device thereof are allocated to an application.

A second identifying method is a method of identifying using a unique value (e.g. PCI bus number, device number, and function number) of an IO device (e.g. USB control unit 212). The PCI bus number, the device number, and the function number are assigned to each of the IO devices by the OS 41 so as not to be duplicated. The allocation setting unit 4311 allocates the designated JO device and the lower level physical device thereof to an application by designating the assigned value.

When determining the device to be allocated, the allocation setting unit 4311 reflects the settings on the routing unit 4312.

The routing unit 4312 transfers display information, sound information, and other information transmitted from the application side to the device driver which supports the device allocated by the allocation setting unit 4311 in the device driver group 42. The above-described information is sent from the device driver to the device of the remote terminal 21 through the CPU-side bridge 112, the network 3, and the IO-side bridge 211.

When an operation, a sound input or the like to a physical device is carried out in the remote terminal 21, operation information, sound information, or other information is sent to the device driver group 42 of the host computer 11 through the IO device, the IO-side bridge 211, the network 3, and the CPU-side bridge 112. The operation information, the sound information, or other information sent from the device driver is transferred to the application to which the device sending the information is allocated in the application group 44. The routing unit 4312 blocks access from the application to a device other than the allocated device and access from the device other than the allocated device to the application.

Usually, one application is connected with one remote terminal. One application is able to be allocated to a plurality of remote terminals. For example, when a user uses the remote multi-client accommodating system according to the present exemplary embodiment as a presentation tool or a conference tool, one application is allocated with a plurality of remote terminals. One remote terminal may be allocated to a plurality of applications. An allocation which is specific to each application-using user may be carried out.

The remote multi-client accommodating system according to the present exemplary embodiment includes device connection bridges (i.e. CPU-side bridge 112 and IO-side bridge 211) for closely connecting the host computer 11 to the IO device of the remote terminal 21 through the network, and allocates the IO device for each user or to each of the applications. A specific user and a specific application are separated from other users and other applications, and the IO device and the physical device of the remote terminal 21 are used as the physical resources of the host computer 11. Therefore, the remote multi-client accommodating system according to the present exemplary embodiment is able to improve IO performance of remote connection from the remote terminal 21 to the host computer 11.

Because the remote multi-client accommodating system according to the present exemplary embodiment does not use remote-dedicated software such as emulation, an IO device which is available by software is not restricted. Therefore, restriction on the IO devices is eased.

### Exemplary Embodiment 2

In the remote multi-client accommodating system according to the present invention remote terminals 21 to 2n having various structures as shown in the present exemplary embodiment are able to be used in addition to the remote terminals 21 to 2n having the structures according to the first exemplary embodiment. In the structure of the remote multi-client accommodating system according to the present exemplary embodiment, a part of the structure which is not explained is the same as the structure of the first exemplary embodiment concerning a part which is not described specifically.

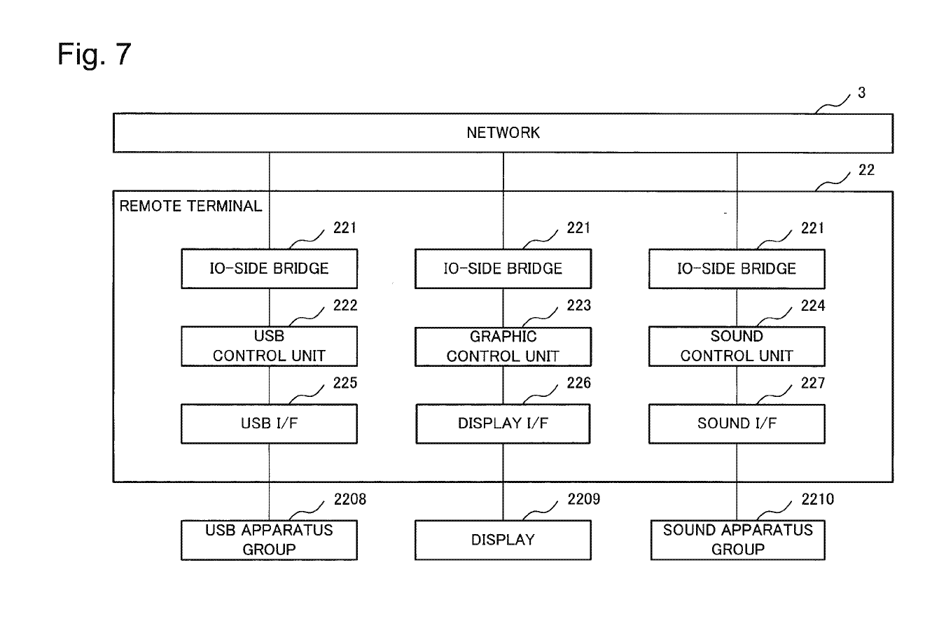

FIG. 7 is a block diagram illustrating a structure of a remote terminal 22 of the second exemplary embodiment (i.e. Exemplary embodiment 2). As shown in FIG. 7, the remote terminal 22 of the second exemplary embodiment includes three IO-side bridges 221, a USB control unit 222, a graphic control unit 223, a sound control unit 224, a USB interface (I/F) 225, a display I/F 226, and a sound I/F 227.

The three IO-side bridges 221 are connected by the network 3, Ethernet, and the like. The three IO-side bridges 221 are connected with the USB control unit 222, the graphic control unit 223, and the sound control unit 224, respectively, by a computer internal bus such as a PCI bus, a PCI Express bus, or the like.

The USB control unit 222 is connected with a USB apparatus group 2208 by the USB bus through the USB I/F 225. The USB apparatus group 2108 includes, for example, a USB keyboard, a USB mouse, a USB storage device, a USB camera, and the like.

The graphic control unit 223 is connected with a display 2209 though the display I/F 226.

The sound control unit 224 is connected with a sound apparatus group 2210 though the sound I/F 227. The sound apparatus group 2110 includes, for example, a speaker, a headphone, a headset, and the like.

In other words, the remote terminal 22 is designed so that the graphic control unit 223 and the sound control unit 224 are PCI/PCI Express devices, and the graphic control unit 223 and the sound control unit 224 are accommodated by the different IO-side bridges. The graphic control unit 223 and the sound control unit 224 may be integrated into one control unit.

In this case, a plurality of IO-side bridges 221 and CPU-side bridges 112 are connected with one another, and works as a PCI Express Switch having one Upstream port and a plurality of Downstream ports.

The method of designating the device when the device control unit 43 of the home computer 11 allocates a physical device is, regarding the first identifying method, the same as the method described in the first exemplary embodiment. Regarding the second identifying method, the method of designating the device differs from the second identifying method of the first exemplary embodiment in designating a unique value (i.e. a PCI bus number, a device number, or a function number) of each of IO devices (e.g. the USB control unit 222, the graphic control unit 223, and the sound control unit 224).

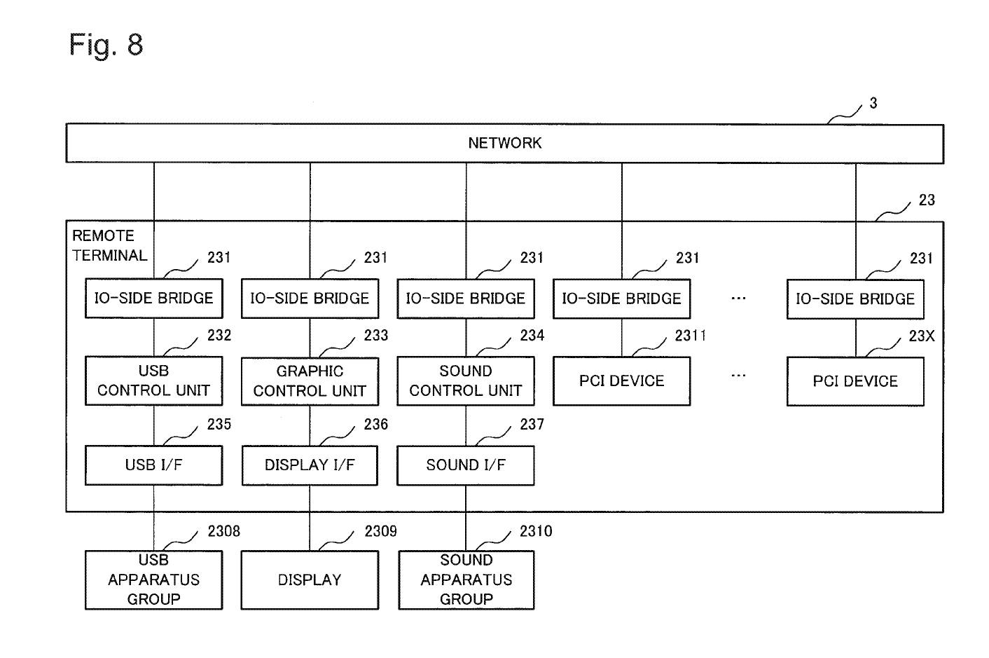

Next, another example the structure of the remote terminal of the second exemplary embodiment is described. FIG. 8 is a block diagram illustrating a structure of a remote terminal 23 according to the second exemplary embodiment. The remote terminal 23 shown in FIG. 8 has a structure including the structure of the remote terminal 22 shown in FIG. 7 and, in addition, a part accommodating arbitrary PCI Express device.

PCI devices 2311 to 23x are arbitrary PCI Express devices, for example, a storage device, an accelerator engine, and the like. The PCI Express devices are connected with the IO-side bridges 231, respectively, and are able be used as resources of the host computer.

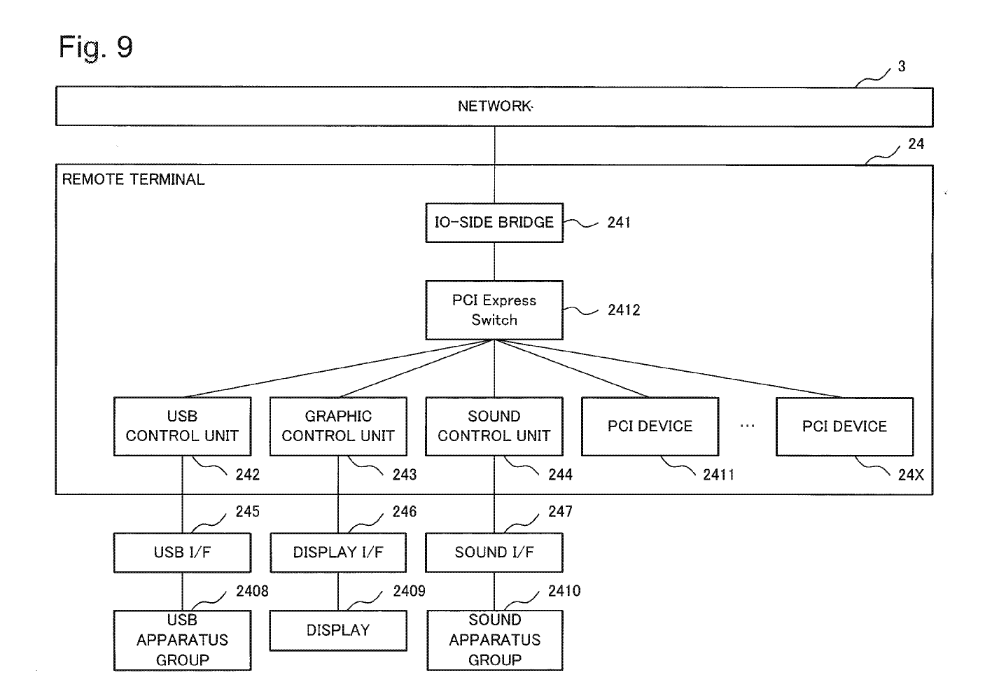

Next, yet another example of the structure of the remote terminal of the second exemplary embodiment is described. FIG. 9 is a block diagram illustrating a structure of a remote terminal 24 according to the second exemplary embodiment. In the remote terminal 24 shown in FIG. 9, an IO-side bridge 241 is connected with a PCI Express switch 2412, and the PCI Express switch 2412 is connected with a USB control unit 242, a graphic control unit 243, a sound control unit 244, and PCI devices 2411 to 24x.

The USB control unit 242 is connected with a USB apparatus 2208 by the USB bus through a USB I/F 225. The USB apparatus group 2208 includes, for example, a USB keyboard, a USB mouse, a USB storage device, a USB camera, and the like.

The graphic control unit 243 is connected with a display 2409 though a display I/F 246.

The sound control unit 244 is connected with a sound apparatus group 2410 though the sound I/F 247. The sound apparatus group 2110 includes, for example, a speaker, a headphone, a headset, and the like.

The remote terminal 21 which is shown in the first exemplary embodiment, and the remote terminal 22, the remote terminal 23, and the remote terminal 24 which are shown in the present exemplary embodiment are compatible with one another, and may exist simultaneously in the remote multi-client accommodating system.

The remote multi-client accommodating system according to the present exemplary embodiment has a structure in which the graphic control unit and the sound control unit are directly connected with the IO-side bridge through a computer internal bus. The remote multi-client accommodating system according to the present exemplary embodiment enables increase in speed and enlargement in capacity of data transmission, compared with a structure in which the graphic control unit and the sound control unit are connected with the IO-side bridge through the USB bus and the USB control unit.

In the remote multi-client accommodating system according to the present exemplary embodiment is able to improve performance, because the graphic control unit and the sound control unit are separately connected through the computer internal bus and, therefore, traffic does not concentrate in the USB control unit.

In the remote multi-client accommodating systems according to the present exemplary embodiment, which are shown in FIG. 8 and FIG. 9, are able to improve versatility by being equipped with a PCI device other than the graphic and sound devices.

The remote multi-client accommodating system according to the present exemplary embodiment, which is shown in FIG. 9, is able to increase an IO accommodation rate of a terminal by increasing hierarchies of a tree structure of PCI Express.

### Exemplary Embodiment 3

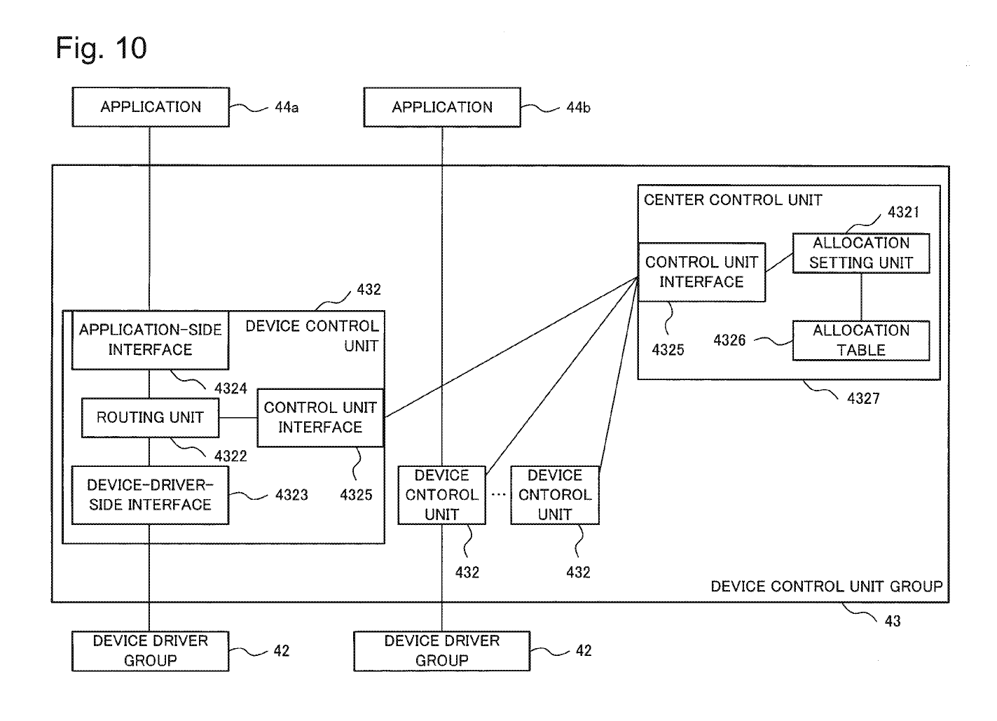

FIG. 10 is a block diagram illustrating a device control unit group 43 of a third exemplary embodiment (i.e. Exemplary embodiment 3). In the present exemplary embodiment, the structure except the device control unit group 43 is the same as the structure of the first exemplary embodiment or the second exemplary embodiment. As shown in FIG. 10, a plurality of the device control unit group 43 according to the present exemplary embodiment include a central control unit 4327, and the central control unit 4327 determines allocation relation between IO devices and physical devices of the remote terminals 21 to 2n and a plurality of applications.

The device control unit group 43 according to the present exemplary embodiment includes a plurality of device control units 432 and the central control unit 4327. The plurality of device control units 432 are connected with the central control unit 4327 through a control unit interface 4325.

The device control unit 432 includes a routing unit 4322, a device-driver-side interface 4323, an application-side interface 4324, and the control unit interface 4325.

The central control unit 4327 includes an allocation setting unit 4321, the control unit interface 4325, and an allocation table 4326.

The allocation setting unit 4321 is connected with the allocation table 4326 storing information on a device of the remote terminal.

The allocation table 4326 stores collected information. The collected information includes information indicating whether or not each IO device of a remote terminal is already allocated. If an IO device is already allocated, the collected information includes information on the application and the IO device which are already allocated, a unique value (e.g. PCI bus number, device number, or function number) of the IO device, information on a device type, and the like.

The allocation setting unit 4321 refers to the allocation table 4326, and determines allocation of applications, and IO devices and physical devices. The allocation setting unit 4321 performs setting of the routing unit 4322 through the control unit interface 4325 on the basis of the allocation which is determined.

The routing unit 4322 is connected with the device-driver-side interface 4323 and the application-side interface 4324. The routing unit 4322 transfers display information, sound information, and other information transmitted from the application to the device driver (i.e. one of device driver group 42) supporting the physical device to which the application is allocated.

The routing unit 4322 transfers the display information, the sound information, and other information transmitted from the device driver supporting the physical device to the application to which the physical device is allocated in the application group 44.

In the remote multi-client accommodating system according to the present exemplary embodiment, the device control unit group 43 includes the central control unit 4327, and the central control unit 4327 intensively manages devices. Therefore, even when failure occurs in allocation between a specific application and a device, it is possible to prevent occurrence of an idle device by taking measures, such as allocating another device. Accordingly, allocation of the devices to the applications is efficiently performed.

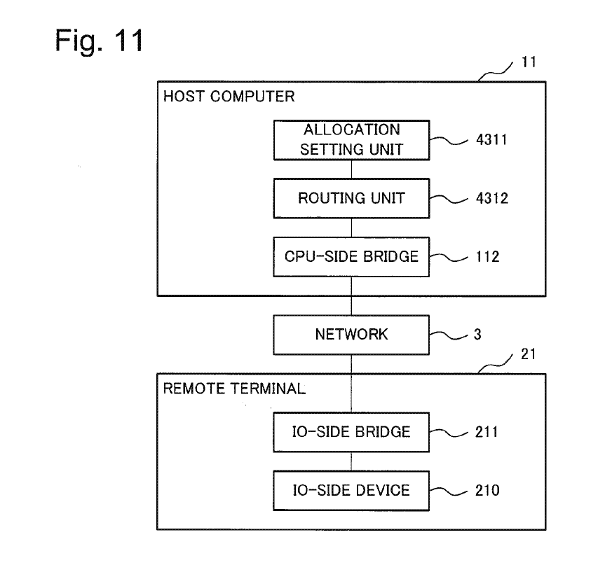

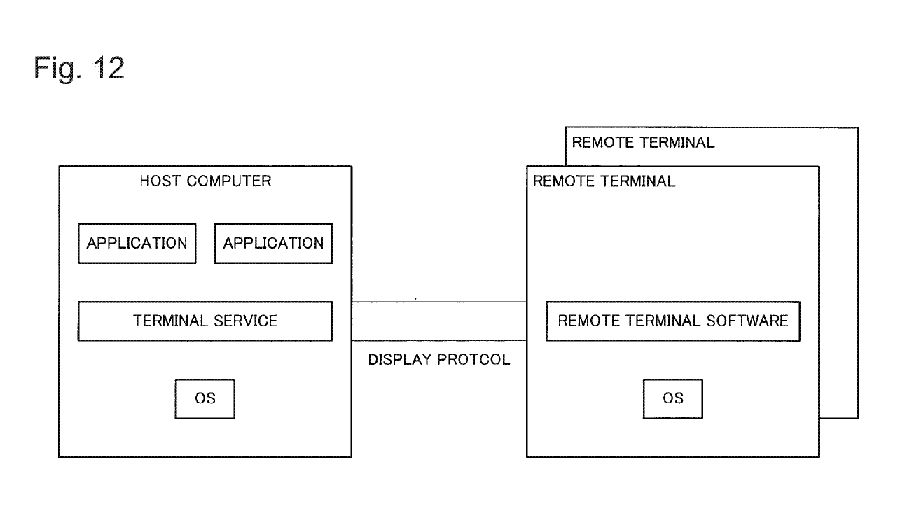

FIG. 11 is a block diagram illustrating a main part of the remote multi-client accommodating system according to the present invention. As shown in FIG. 11, the remote multi-client accommodating system includes the host computer 11 and the remote terminal 21 which are connected with each other through the network 3. The remote terminal 21 includes the IO device 210 which is used as physical resources of the host computer, and the IO-side bridge 211 which performs processing of connection with the host computer 11. The host computer 11 includes the CPU-side bridge 112 which performs processing of connection with the remote terminal 21, the allocation setting unit 4311 which allocates the IO device 210 of the remote terminal 21 to an application running on the host computer 11, and the routing unit 4312 which transfers information between the application to which the IO device 210 is allocated and the IO device 210 and prevents processing of transferring information between the application which is not allocated and the IO device 210.

The exemplary embodiments described above also disclose the remote multi-client accommodating systems described in following items (1) to (3).

(1) The remote multi-client accommodating system including a host computer (e.g. the host computers 11 to 1n) and a remote terminal (e.g. the remote terminals 21 to 2n) which are connected with each other through a network (e.g. the network 3) wherein the remote terminal includes: an IO device (e.g. the USB control units 212, 222, 232, 242, the graphic control units 213, 223, 233, 243, the sound control unit 214, 224, 234, 244, and the PCI device 2311 to 231n) which is used as physical resources of the host computer; and an IO-side bridge (e.g. the IO-side bridges 211, 221, 231, 241) which performs processing of connection with the host computer 11, the host computer 11 includes: a CPU-side bridge (e.g. the CPU-side bridge 112) which performs processing of connection with the remote terminal, an allocation setting unit (e.g. the allocation setting units 4311, 4321) which allocates the IO device of the remote terminal to an application running on the host computer, and a routing unit (e.g. the routing units 4312, 4322) which performs processing of transferring information between the application to which the IO device is allocated and the IO device, and prevents processing of transferring information between the application and the IO device which is not allocated to the application.

(2) In the remote multi-client accommodating system may be structured so that the allocation setting unit designates a unique value of the IO-side bridge as an identifier when allocating the IO device of the remote terminal to the application. According to the remote multi-client accommodating system, the IO device which is allocated can be separated from other users definitely and easily.

(3) In the remote multi-client accommodating system may be structured so that the allocation setting unit designates a unique value of the IO device as an identifier when allocating the IO device of the remote terminal to the application. According to the remote multi-client accommodating system, the IO device which is allocated can be separated from other users definitely and easily.

This application is based upon and claims the benefit of priority from Japanese patent application No. 2012-120753, filed on May 28, 2012, the disclosure of which is incorporated herein in its entirety by reference.

While the present invention has been particularly shown and described with reference to exemplary embodiments thereof, the present invention is not limited to these embodiments. It will be understood by those of ordinary skill in the art that various changes in form and details may be made therein without departing from the spirit and scope of the present invention as defined by the claims.

### INDUSTRIAL APPLICABILITY

The present invention is applicable to a presentation, a conference, and the like, when users are separately located.

### Reference Signs List

3 network
11 to 1n host computer
21 to 2n remote terminal
210 IO device
211, 221, 231, 241 IO-side bridge
112 CPU-side bridge
4311, 4321 allocation setting unit
4312, 4322 routing unit

What is claimed is:

1. A remote multi-client accommodating system including a host computer and a remote terminal which are connected with each other through a network, wherein
the remote terminal comprises:
an IO device that is used as physical resources of the host computer; and
an IO-side bridge that performs processing of connecting with the host computer, and
the host computer comprises:
a CPU-side bridge that performs processing of connecting with the remote terminal;
an allocation setting unit that allocates the IO device of the remote terminal to an application running on the host computer; and
a routing unit that performs processing of transferring information between the application to which the IO device is allocated and the IO device, and prevents processing of transferring information between the application and the IO device which is not allocated to the application.

2. The remote multi-client accommodating system according to claim 1, wherein
when allocating the IO device of the remote terminal to the application, the allocation setting unit designates a unique value of the IO-side bridge as an identifier.

3. The remote multi-client accommodating system according to claim 1, wherein
when allocating the IO device of the remote terminal to the application, the allocation setting unit designates a unique value of the IO device as an identifier.

4. The remote multi-client accommodating system according to claim 1, wherein
the allocation setting unit includes a table having information indicating whether or not the IO device is allocated, and allocates the IO device to the application by referring to the table.

5. A host computer being used in a remote multi-client accommodating system and being connected with a remote terminal through a network, comprising:
a CPU-side bridge that connects with an IO-side bridge of the remote terminal through the network, and performs processing of connecting with the remote terminal;
an allocation setting unit that allocates the IO device of the remote terminal to an application running on the host computer, the IO device being used as physical resources; and
a routing unit that performs processing of transferring information between the application to which the IO device is not allocated and the IO device, and prevents processing of transferring information between the application and the IO device which is not allocated to the application.

6. The host computer according to claim 5, wherein
when allocating the IO device of the remote terminal to the application, the allocation setting unit designates a unique value of the IO-side bridge as an identifier.

7. The host computer according to claim 5, wherein
when allocating the IO device of the remote terminal to the application, the allocation setting unit designates a unique value of the IO device as an identifier.

8. A remote multi-client resource-allocating method being used in a host computer being connected with a remote terminal through a network, comprising:
connecting with an IO-side bridge of the remote terminal through the network, and performing processing of connecting with the remote terminal;
allocating an IO device of the remote terminal to an application running on the host computer, the IO device being used as physical resources; and
performing processing of transferring information between the application to which the IO device is allocated and the IO device, and preventing processing of transferring information between the application and the IO device which is not allocated to the application.

9. The remote multi-client resource-allocating method according to claim 8, further comprising
designating a unique value of the IO-side bridge as an identifier when the IO device of the remote terminal is allocated to the application.

10. The remote multi-client resource-allocating method according to claim 8, further comprising:
designating a unique value of the IO device as an identifier when the IO device of the remote terminal is allocated to the application.
